(19) United States
(12) Patent Application Publication
(10) Pub. No.: US 2024/0172799 A1
(43) Pub. Date: May 30, 2024

(54) AEROSOL-GENERATING DEVICE WITH PHOTONIC HEATING MEANS

(71) Applicant: Philip Morris Products S.A., Neuchatel (CH)

(72) Inventors: Sebastien CAPELLI, Cernier (CH); Robert William EMMETT, Ingatestone (GB); Ana Isabel GONZALEZ FLOREZ, Preverenges (CH)

(73) Assignee: Philip Morris Products S.A., Neuchatel (CH)

(21) Appl. No.: 18/552,294

(22) PCT Filed: Mar. 24, 2022
(86) PCT No.: PCT/EP2022/057756

§ 371 Date: Sep. 25, 2023

(30) Foreign Application Priority Data
Mar. 29, 2021 (EP) 21165643.4

(51) Int. Cl. A24F 40/46

(52) U.S. Cl. CPC A24F 40/46

(57) ABSTRACT

An aerosol-generating device is provided, including: a heating chamber configured to receive an aerosol-forming substrate; and a heater assembly configured to heat the aerosol-forming substrate, the heater assembly including a photonic device configured to generate a beam of electromagnetic radiation, the aerosol-generating device being configured to heat the aerosol-forming substrate by directing the beam of electromagnetic radiation onto the aerosol-forming substrate, and the heating chamber being arranged between the photonic device and a mouth-end of the aerosol-generating device with respect to a longitudinal axis of the aerosol-generating device. An aerosol-generating system including the aerosol-generating device and an aerosol-generating article is also provided.

The present disclosure relates to an aerosol-generating device. The present disclosure further relates to an aerosol-generating system comprising an aerosol-generating device and an aerosol-generating article.

It is known to provide an aerosol-generating device for generating an inhalable vapor. Such devices may heat an aerosol-forming substrate contained in an aerosol-generating article without burning the aerosol-forming substrate. The aerosol-generating article may have a shape suitable for insertion of the aerosol-generating article into a heating chamber of the aerosol-generating device. For example, the aerosol-generating article may have a rod shape. A heating element may be arranged in or around the heating chamber for heating the aerosol-forming substrate once the aerosol-generating article is inserted into the heating chamber of the aerosol-generating device.

It is known to heat the aerosol-forming substrate by heating a surface which is in thermal contact with the aerosol-forming substrate. The heat from the heated surface is transferred to the aerosol-forming substrate by means of heat conduction. This often requires an intimate physical contact between the heated surface and the aerosol-forming substrate. Generally, residues generated from a heated aerosol-forming substrate may accumulate on heated surfaces contacting the substrate.

It would be desirable to have an aerosol-generating device that may heat the aerosol-forming substrate in a contactless manner. It would be desirable to have an aerosol-generating device that may heat the aerosol-forming substrate without having a heated surface physically contacting the aerosol-forming substrate. It would be desirable to have an aerosol-generating device that may heat the aerosol-forming substrate with less residue accumulation.

It would be desirable to provide an aerosol-generating device having only low thermal mass to be heated. It would be desirable to provide an aerosol-generating device that can be quickly heated. It would be desirable to provide an aerosol-generating device that allows for the temperature of the aerosol-forming substrate to quickly respond to a change in the heating protocol.

It would be desirable to provide an aerosol-generating device with low thermal hysteresis effects. It would be desirable to provide an aerosol-generating device that efficiently heats the substrate. It would be desirable to provide an aerosol-generating device that allows for the temperature of the aerosol-forming substrate to quickly respond to a change of the target temperature.

According to an embodiment of the invention there is provided an aerosol-generating device. The aerosol-generating device may comprise a heating chamber for receiving an aerosol-forming substrate. The aerosol-generating device may comprise a heater assembly for heating the aerosol-forming substrate. The heater assembly may comprise a photonic device configured for generating a beam of electromagnetic radiation. The aerosol-generating device may be configured for heating the aerosol-forming substrate by directing the beam of electromagnetic radiation towards the aerosol-forming substrate.

According to an embodiment of the invention there is provided an aerosol-generating device. The aerosol-generating device comprises a heating chamber for receiving an aerosol-forming substrate. The aerosol-generating device comprises a heater assembly for heating the aerosol-forming substrate. The heater assembly comprises a photonic device configured for generating a beam of electromagnetic radiation. The aerosol-generating device is configured for heating the aerosol-forming substrate by directing the beam of electromagnetic radiation towards the aerosol-forming substrate.

The heating chamber may comprise a first side wall parallel to a longitudinal axis of the heating chamber. The heating chamber may comprise a second side wall arranged in perpendicular to the first side wall. The surface of the first side wall may be larger than the surface of the second side wall. The aerosol-generating device may be configured for heating the aerosol-forming substrate by directing the beam of electromagnetic radiation through at least a portion of the first side wall of the heating chamber and towards the aerosol-forming substrate.

The incident beam of electromagnetic radiation may enter the heating chamber, for example, via a transparent portion of the first side wall, or via an opening in the first side wall. Upon the electromagnetic radiation, the temperature of the aerosol-forming substrate may rise up to a temperature of the aerosol-forming substrate required in the process of aerosol formation.

The aerosol-generating device may be configured for heating the aerosol-forming substrate by directing the beam of electromagnetic radiation to the aerosol-forming substrate, or onto the aerosol-forming substrate. The beam of electromagnetic radiation directed to or onto the aerosol-forming substrate may at least partly penetrate into the aerosol-forming substrate.

As used herein, the terms ‘surface of the first side wall’ and ‘surface of the second side wall’ refer to the respective areas, or surface areas, of the side walls. The area of the first side wall exceeds the area of the second side wall.

For example, the heating chamber may have the shape of an elongated cylinder resembling to some extent the shape of a traditional cigarette. In such embodiment, the first side wall may be the cylindrical side wall of the elongated cylinder, and the second side wall may be one or both of the top and bottom walls of the cylinder.

For example, the heating chamber may have the shape of a flat cylinder resembling to some extent the shape of a disc or a coin. In such embodiment, the first side wall may be one or both of the top and bottom walls of the cylinder, and the and the second side wall may be the cylindrical side wall of the flat cylinder.

By illuminating the substrate via a first side wall of the heating chamber with a large area, a large surface area of the aerosol-forming substrate may advantageously be illuminated. This may be particularly advantageous when the photonic device utilizes electromagnetic radiation with limited penetration depth into the aerosol-forming substrate.

The aerosol-generating device may comprise an airflow path extending through the heating chamber in a direction parallel to the first side wall of the heating chamber.

The beam of electromagnetic radiation may be directed through the first side wall of the heating chamber, and the airflow path may extend in a direction parallel to the first side wall of the heating chamber. The direction of the beam of electromagnetic radiation entering the heating chamber, may be substantially orthogonal to the direction of the airflow path within the heating chamber.

In contrast to conduction or convection, the photonic device transfers energy via electromagnetic waves. By heating the aerosol-forming substrate by means of a beam of electromagnetic radiation, the aerosol-generating device may heat the aerosol-forming substrate in a contactless manner. No, or only little, physical contact between the aerosol-forming substrate and a heated surface of a heat conducting element is required for heating the aerosol-forming substrate. Omitting or reducing a heated surface of a heat conducting element may reduce the overall thermal mass to be heated. This may allow for high speed and high efficiency heating.

Having no, or only little, physical contact between the aerosol-forming substrate and a heated surface may also reduce residue accumulation during use.

A low thermal mass may be beneficial for the aerosol-generating device to more quickly heat the aerosol-forming substrate to a desired temperature. A low thermal mass may be beneficial for the aerosol-generating device to have less thermal hysteresis effects. A low thermal mass may be beneficial for the aerosol-generating device to more efficiently heat the substrate.

A photonic device may have shorter on/off response times when compared to other heaters as, for example, resistive heaters. The short response time of the photonic device may be beneficial for the aerosol-generating device to more quickly heat the aerosol-forming substrate to a desired temperature. The short response time of the photonic device may be beneficial for the aerosol-generating device to have less thermal hysteresis effects. The short response time of the photonic device may be beneficial for the aerosol-generating device to more efficiently heat the substrate. For example, heating may be quickly turned off and on again, depending on whether a puff being detected by a puff sensor of the aerosol-generating device. A shorter response time may allow for a more precise dynamic heat control when varying power supply versus time. For example, the temperature of the aerosol-forming substrate may be quickly raised to a desired temperature by increasing the supplied power when the temperature has fallen below a predetermined threshold.

The photonic device may comprise a light source. The photonic device may comprise one or more of semiconductor-based electronics, a laser, a light-emitting diode, a laser diode, and an IR emitter. The photonic device may comprise an IR laser diode. The photonic device may comprise a plurality of light sources. The photonic device may comprise 2, 3, 4, 5, 6, 7, 8, 9, or 10 light sources. The photonic device may comprise 2, 3, 4, 5, 6, 7, 8, 9, or 10 IR laser diodes.

As used herein, ‘IR’ refers to infrared light. Generally, infrared light may be electromagnetic radiation in a range of wavelengths from about 780 nanometers to about 15 micrometers, or even to about 1000 micrometers.

The photonic device may be configured for emitting electromagnetic radiation in a range of wavelengths of between 800 nanometers and 2500 nanometers. The photonic device may be configured for emitting electromagnetic radiation in a range of wavelengths of between 1100 nanometers and 2000 nanometers. The photonic device may be configured for emitting electromagnetic radiation in a range of wavelengths of between 1400 nanometers and 1700 nanometers. The photonic device may be configured for emitting electromagnetic radiation at a wavelength of about 1550 nanometers.

Different materials absorb IR radiation at different frequencies. A careful choice of wavelength can promote that certain substances are efficiently heated while others remain at substantially lower temperatures. Accordingly, the photonic device of the invention may allow for targeted heating as a function of one or more components of the aerosol-forming substrate. The targeted IR radiation does not necessarily heat the surrounding air. This means more efficient heating can be achieved. Also, more design freedom is available, since an air gap may reduce thermal losses. Thus, potentially less insulating material may become necessary.

Another advantage of IR heating means may be fast thermal response. The aerosol-forming substrate may be substantially heated during the time of irradiation, only.

The photonic device may function as an IR emitter. For choosing a suitable IR emitter, the composition of the aerosol-forming substrate should be considered. The IR emitter may be selected in view of one or more IR emitter properties. One or more IR emitter properties may be selected in dependence on one or more components of the aerosol-forming substrate. For example, said one or more IR emitter properties may comprise any one or combination of: wavelength, frequency, spot size, swept source, pulsed vs continuous wave, energy and power. For example, a wavelength of the IR emitter may be selected in view of the absorption of the IR light by one or more components of the aerosol-forming substrate. A wavelength of the IR emitter may be selected in view of the transmission of the IR light by one or more components of the aerosol-forming substrate.

A wavelength of the IR emitter may correspond to the IR absorption bands of a component of the aerosol-forming substrate. A wavelength of the IR emitter may correspond to the IR absorption bands of two or more components of the aerosol-forming substrate.

For example, a wavelength of the IR emitter may correspond to the IR absorption bands of one or more of glycerol, molasses, sugars, inverted sugars, tobacco, tobacco derivate, or any other component of the aerosol-forming substrate as will later be described.

The term “a wavelength” may refer to a single wavelength, a plurality of single wavelengths, a range of wavelengths, a plurality of ranges of wavelengths, or any combination thereof.

For example, there may be a relatively large amount of glycerol present in the aerosol-forming substrate and the wavelength requirements may be adapted to the strong absorption bands of glycerol. Glycerol's strong IR absorption bands are found at wavelengths of the IR light between 1300 nanometers and 2000 nanometers. Accordingly, the IR emitter may emit IR light in a range of from 800 nanometers to 2300 nanometers, preferably from 1300 nanometers to 2000 nanometers.

The IR emitter may be adapted to the IR absorption bands of any of the components of the aerosol-forming substrate. The IR emitter may be adapted to the IR transmission of any of the components of the aerosol-forming substrate.

Control over the intensity of the heating of the aerosol-forming substrate by the IR emitter may be achieved by moving the wavelength of heating slightly off resonance from that already selected. This may advantageously maximize absorption of the desired compound of the aerosol-forming substrate, for example glycerol. In some embodiments, control over the intensity of the heating of the aerosol-forming substrate may be achieved by changing the power supplied to the IR emitter.

The photonic device may be configured for irradiating a surface area of the aerosol-forming substrate of between 0.1 square centimeter and 10 square centimeters. The photonic device may be configured for irradiating a surface area of the aerosol-forming substrate of between 0.2 square centimeter and 4.1 square centimeters. The photonic device may be configured for irradiating a surface area of the aerosol-forming substrate of about 2 square centimeters.

The power of the beam of electromagnetic radiation may be in the range of between 0.1 Watt and 30 Watts. The power of the beam of electromagnetic radiation may be in the range of between 0.5 Watt and 25 Watts. The power of the beam of electromagnetic radiation may be in the range of between 2 Watts and 6 Watts. The power of the beam of electromagnetic radiation may be about 4 Watts.

The energy density of the beam of electromagnetic radiation maybe in a range of between 0.5 Watt per square centimeter to 100 Watts per square centimeter. The energy density of the beam of electromagnetic radiation maybe in a range of between 1 Watt per square centimeter to 20 Watts per square centimeter. The energy density of the beam of electromagnetic radiation maybe in a range of between 2 Watts per square centimeter to 6 Watts per square centimeter.

The aerosol-generating device may be configured such that a distance along an optical path between the photonic device and a surface of the aerosol-forming substrate is between 0.1 centimeter and 50 centimeters. The aerosol-generating device may be configured such that a distance along an optical path between the photonic device and a surface of the aerosol-forming substrate is between 2 centimeters and 30 centimeters.

The aerosol-generating device may comprise a cooling system for cooling the photonic device. The cooling system may comprise an airflow path extending from an air inlet to the heating chamber past the photonic device. The photonic device may be cooled by the outside air entering the device via the air inlet and passing the photonic device. Heat emitted by the photonic device may be used to preheat the air passing the photonic device before entering the heating chamber. Thereby, energy efficiency of the aerosol-generating device may be additionally increased. The cooling system may utilize passive cooling, active cooling, or both. The cooling system may comprise a conduit of thermally conductive material. The cooling system may ensure that the photonic device is kept at a safe operational temperature, thereby avoiding damage.

The aerosol-generating device may comprise a safety interlock switch. The safety interlock switch may be configured to enable activation of the photonic device only under certain circumstances, for example, only when an aerosol-forming substrate is inserted into the heating chamber or only when a lid of the heating chamber is securely closed. The safety interlock switch may ensure to avoid the leak of electromagnetic radiation, for example IR light. The safety interlock switch may help preserving user safety. The safety interlock switch may be based on non-contact principles such as magnetic safety interlock switches. The safety interlock switch may be electric circuit based.

The photonic device of the invention may be used as the only heating means for heating the aerosol-forming substrate. In some embodiments, the photonic device of the invention may be used in combination with one or more additional heating means. Any heating means may be used as an additional heating means. Examples comprise electrical heating means, such as a resistive heating means, inductive heating means or a combination of both a resistive heating means and an inductive heating means.

The aerosol-generating device may comprise control electronics. The control electronics may comprise a controller. The control electronics may comprise a memory. The memory may comprise instructions that cause one or more components of the aerosol-generating device to carry out a function or aspect of the control electronics. Functions attributable to control electronics in this disclosure may be embodied as one or more of software, firmware, and hardware. The memory may be a non-transient computer readable storage medium.

In particular, one or more of the components, such as controllers, described herein may comprise a processor, such as a central processing unit (CPU), computer, logic array, or other device capable of directing data coming into or out of the control electronics. The controller may comprise one or more computing devices having memory, processing means, and communication hardware. The controller may comprise circuitry used to couple various components of the controller together or with other components operably coupled to the controller. The functions of the controller may be performed by hardware. The functions of the controller may be performed by instructions stored on a non-transient computer readable storage medium. The functions of the controller may be performed by both hardware and by instructions stored on a non-transient computer readable storage medium.

Where the controller comprises a processor, the processor may, in some embodiments, comprise any one or more of a microprocessor, a microcontroller, a digital signal processor (DSP), an application specific integrated circuit (ASIC), a field-programmable gate array (FPGA), and equivalent discrete or integrated logic circuitry. In some embodiments, the processor may comprise multiple components, such as any combination of one or more microprocessors, one or more controllers, one or more DSPs, one or more ASICs, and one or more FPGAs, as well as other discrete or integrated logic circuitry. The functions attributed to the controller or processor herein may be embodied as software, firmware, hardware, or any combination thereof. While described herein as a processor-based system, an alternative controller could utilize other components such as relays and timers to achieve the desired results, either alone or in combination with a microprocessor-based system.

In one or more embodiments, the exemplary systems, methods, and interfaces may be implemented using one or more computer programs using a computing apparatus, which may comprise one or more processors, memory, or both memory and one or more processors. Program code, logic or both code and logic described herein may be applied to input data or information to perform functionality described herein and generate desired output data/information. The output data or information may be applied as an input to one or more other devices or methods as described herein or as would be applied in a known fashion. In view of the above, it will be readily apparent that the controller functionality as described herein may be implemented in any manner known to one skilled in the art.

In some embodiments, the control electronics may comprise a microprocessor, which may be a programmable microprocessor. The electronic circuitry may be configured to regulate a supply of power. The power may be supplied to the photonic device in the form of pulses of electrical current.

The aerosol-generating device may comprise a temperature sensor. The temperature sensor may comprise a thermocouple. The temperature sensor may be operably coupled to the control electronics to control the temperature of the heating elements. The temperature sensor may be positioned in any suitable location. For example, the temperature sensor may be configured to monitor the temperature of the aerosol-forming substrate being heated. In addition, or alternatively, the temperature sensor may be configured to monitor the temperature of the photonic device. The sensor may transmit signals regarding the sensed temperature to the control electronics, which may adjust power of the photonic device to achieve a suitable temperature at the sensor.

The photonic device may heat the aerosol-forming substrate by electromagnetic waves to generate an aerosol. In some embodiments, the aerosol-forming substrate is preferably heated to a temperature in a range from about 150° C. to about 400° C.

In some embodiments, the aerosol-forming substrate is heated to a temperature in a range from about 150° C. to about 250° C., preferably from about 180° C. to about 230° C., more preferably from about 200° C. to about 230° C. In some embodiments, the aerosol-forming substrate is a liquid aerosol-forming substrate and is heated to a temperature in a range from about 150° C. to about 250° C., preferably from about 180° C. to about 230° C., more preferably from about 200° C. to about 230° C. In some embodiments, the aerosol-forming substrate is a solid aerosol-forming substrate and is heated to a temperature in a range from about 150° C. to about 250° C., preferably from about 180° C. to about 230° C., more preferably from about 200° C. to about 230° C. In some embodiments, the aerosol-forming substrate is a solid aerosol-forming substrate comprising tobacco material and is heated to a temperature in a range from about 150° C. to about 250° C., preferably from about 180° C. to about 230° C., more preferably from about 200° C. to about 230° C.

In some embodiments, the aerosol-forming substrate is heated to a temperature in a range from about 230° C. to about 400° C., preferably from about 250° C. to about 350° C. In some embodiments, the aerosol-forming substrate is a solid aerosol-forming substrate and is heated to a temperature in a range from about 230° C. to about 400° C., preferably from about 250° C. to about 350° C. In some embodiments, the aerosol-forming substrate is a solid aerosol-forming substrate comprising tobacco material and is heated to a temperature in a range from about 230° C. to about 400° C., preferably from about 250° C. to about 350° C.

The aerosol-generating device may be a hand-held device.

The aerosol-generating device may be a heat-not-burn device. A heat-not-burn device heats the aerosol-forming substrate without combusting it. A heat-not-burn device heats the aerosol-forming substrate to temperatures below its combustion temperature.

The heating chamber may be arranged between the photonic device and a mouth-end of the aerosol-generating device with respect to a longitudinal axis of the aerosol-generating device.

The aerosol-generating device may comprise a re-closable lid for insertion of the aerosol-forming substrate into the heating chamber.

The re-closable lid may be located at a side wall of the aerosol-generating device between a proximal end of the heating chamber and a distal end of the heating chamber with respect to a longitudinal axis of the aerosol-generating device. The re-closable lid may be located at a side wall of the heating chamber. The re-closable lid may be located at the first side wall of the heating chamber. The re-closable lid may be located at the second side wall of the heating chamber.

The re-closable lid may comprise a hinged door or a sliding door.

At least a portion of a wall of the heating chamber may comprise a window. At least a portion of the first side wall of the heating chamber may comprise a window. The window may be substantially transparent for the beam of electromagnetic radiation emitted by the photonic device. The window may be located at a distal end of the heating chamber with respect to a longitudinal axis of the aerosol-generating device. The window may be located at a distal end of the heating chamber with respect to a longitudinal axis of the heating chamber. The window may be located at a proximal end of the heating chamber with respect to a longitudinal axis of the heating chamber. The window may be located between at a distal end of the heating chamber and a proximal end of the heating chamber with respect to a longitudinal axis of the aerosol-generating device.

The window may comprise one or more of fused silica, lithium fluoride, magnesium fluoride, calcium fluoride, barium fluoride, silicon, germanium, copper, zinc selenide, and sapphire. Fused silica may be preferred because it is resistant and does not foul easily upon contact with ambient air.

At least a portion of a wall of the heating chamber may comprise an IR blocking material. The IR blocking material may be located at a proximal end of the heating chamber with respect to a longitudinal axis of the aerosol-generating device.

The aerosol-generating device may comprise a beam guiding means for directing the beam of electromagnetic radiation emitted by the photonic device towards the aerosol-forming substrate. The beam guiding means may be configured to manipulate the direction of the beam of electromagnetic radiation. The aerosol-generating device may comprise a beam guiding means for directing the beam of electromagnetic radiation towards the first side wall of the heating chamber.

The beam guiding means may comprise a reflective surface arranged to deflect an incident beam of electromagnetic radiation towards the heating chamber. The beam guiding means may comprise an IR reflecting material.

The reflective surface may be arranged on an inclined wall of the aerosol-generating device. The inclined wall may be inclined at an angle smaller than 90 degrees with respect to a longitudinal axis of the aerosol-generating device. The inclined wall may be arranged coaxially around the first side wall of the heating chamber. The inclined wall may be arranged coaxially around the first side wall of the heating chamber and the first side wall of the heating chamber may comprise an IR transparent material.

One or both of an inner side of a wall of the heating chamber and an inner side of a wall of the aerosol-generating device may comprise or may be coated with an IR reflecting material.

The IR reflecting material may comprise a metal, preferably, aluminium, gold, silver, or any combination or alloy thereof.

The aerosol-generating device may comprise a protective coating on the IR reflecting material. The protective coating may comprise SiO₂ or SiO.

A wall of the aerosol-generating device comprising the IR reflecting material on its inner side may be arranged coaxially around a side wall of the heating chamber. The side wall of the heating chamber coaxially surrounded by the IR reflecting material may comprise an IR transparent material.

A wall of the aerosol-generating device comprising the IR reflecting material may be inclined at an angle smaller than 90 degrees with respect to a longitudinal axis of the aerosol-generating device. The inclined wall may function as a beam guiding means. The inclined wall may be straight or may be curved.

The inclined wall of the aerosol-generating device may be arranged coaxially around a side wall of the heating chamber. The side wall of the heating chamber coaxially surrounded by the inclined wall may comprise an IR transparent material.

The invention further relates to an aerosol-generating system, comprising the aerosol-generating device as described herein and an aerosol-generating article comprising the aerosol-forming substrate. The aerosol-generating article may be configured to be at least partly inserted into the heating chamber. The aerosol-generating article may comprise or may consist of the aerosol-forming substrate.

The aerosol-forming substrate may comprise cast leaf.

The aerosol-forming substrate may have the shape of a disc or a sheet. Thereby, a large surface area with respect to the volume may be achieved. Limited penetration depths of IR radiation may result in superficial heating of the substrate. Thus, the substrate ideally has a large surface area with respect to the volume.

The aerosol-forming substrate may have a diameter of between 5 millimeters and 15 millimeters, preferably about 15 millimeters. The aerosol-forming substrate may have a thickness of between 1 millimeter and 10 millimeters, preferably about 5 millimeters.

The aerosol-forming substrate may have a mass of between 100 milligrams and 1 gram, preferably about 400 milligrams.

The invention further relates to a method for forming an aerosol in an aerosol-generating device. The method comprises generating a beam of electromagnetic radiation by means of a photonic device. The method comprises directing the beam of electromagnetic radiation from the photonic device towards an aerosol-forming substrate. The method comprises heating the aerosol-forming substrate by means of the beam of electromagnetic radiation to generate an aerosol.

The beam of electromagnetic radiation generated by the photonic device may be a beam of IR light. The temperature of the aerosol-forming substrate may increase upon absorption of the IR light. The temperature of the aerosol-forming substrate may increase upon absorption of the IR light until it reaches the vaporization temperature at which an aerosol may be formed.

In one or more embodiments of the method, a wavelength of the beam of IR radiation may be selected to correspond to a wavelength at which at least a component of the aerosol-forming substrate absorbs IR radiation.

As used herein, the term ‘aerosol-forming substrate’ refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

Preferably, the aerosol-forming substrate comprises plant material and an aerosol former. Preferably, the plant material is a plant material comprising an alkaloid, more preferably a plant material comprising nicotine, and more preferably a tobacco-containing material.

Preferably, the aerosol-forming substrate comprises at least 70 percent of plant material, more preferably at least 90 percent of plant material by weight on a dry weight basis. Preferably, the aerosol-forming substrate comprises less than 95 percent of plant material by weight on a dry weight basis, such as from 90 to 95 percent of plant material by weight on a dry weight basis.

Preferably, the aerosol-forming substrate comprises at least 5 percent of aerosol former, more preferably at least 10 percent of aerosol former by weight on a dry weight basis. Preferably, the aerosol-forming substrate comprises less than 30 percent of aerosol former by weight on a dry weight basis, such as from 5 to 30 percent of aerosol former by weight on a dry weight basis.

In some particularly preferred embodiments, the aerosol-forming substrate comprises plant material and an aerosol former, wherein the substrate has an aerosol former content of between 5% and 30% by weight on a dry weight basis. The plant material is preferably a plant material comprising an alkaloid, more preferably a plant material comprising nicotine, and more preferably a tobacco-containing material. Alkaloids are a class of naturally occurring nitrogen-containing organic compounds. Alkaloids are found mostly in plants, but are also found in bacteria, fungi and animals. Examples of alkaloids include, but are not limited to, caffeine, nicotine, theobromine, atropine and tubocurarine. A preferred alkaloid is nicotine, which may be found in tobacco.

An aerosol-forming substrate may comprise nicotine. An aerosol-forming substrate may comprise tobacco, for example may comprise a tobacco-containing material containing volatile tobacco flavour compounds, which are released from the aerosol-forming substrate upon heating. In preferred embodiments an aerosol-forming substrate may comprise homogenised tobacco material, for example cast leaf tobacco. The aerosol-forming substrate may comprise both solid and liquid components. The aerosol-forming substrate may comprise a tobacco-containing material containing volatile tobacco flavour compounds, which are released from the substrate upon heating. The aerosol-forming substrate may comprise a non-tobacco material. The aerosol-forming substrate may further comprise an aerosol former. Examples of suitable aerosol formers are glycerine and propylene glycol.

The term “cast leaf” is used herein to refer to a sheet product made by a casting process that is based on casting a slurry comprising plant particles (for example, clove particles, or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are mixed with a liquid component, typically water, to form a slurry. Other added components in the slurry may include fibres, a binder and an aerosol former. The particulate plant materials may be agglomerated in the presence of the binder. The slurry is cast onto a supportive surface and dried to form a sheet of homogenised plant material.

As used herein, the term ‘aerosol-generating article’ refers to an article comprising an aerosol-forming substrate that is capable of releasing volatile compounds that can form an aerosol. An aerosol-generating article may be disposable.

As used herein, the term ‘aerosol-generating device’ refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term ‘aerosol-generating system’ refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term ‘longitudinal’ is used to describe the direction along the main axis of the aerosol-generating device, or of the heating chamber, and the term ‘transverse’ is used to describe the direction perpendicular to the longitudinal direction. The term ‘longitudinal axis of the aerosol-generating device’ refers to the axis of the aerosol-generating device which corresponds to a direction of greatest expansion of the aerosol-generating device. The term ‘longitudinal axis of the heating chamber’ refers to the axis of the heating chamber which corresponds to a direction of greatest expansion of the heating chamber.

In certain embodiments, the longitudinal axis of the heating chamber is parallel with the longitudinal axis of the aerosol-generating device. For example, where the open end of the chamber is positioned at the proximal end of the aerosol-generating device. In other embodiments, the longitudinal axis of the heating chamber is at an angle to the longitudinal axis of the aerosol-generating device, for example perpendicular to the longitudinal axis of the aerosol-generating device. For example, where the open end of the heating chamber is positioned along one side of the aerosol-generating device such that an aerosol-generating article may be inserted into the heating chamber in direction which is perpendicular to the longitudinal axis of the aerosol-generating device.

As used herein, the term ‘proximal’ refers to a user end, or mouth end of the aerosol-generating-device, and the term ‘distal’ refers to the end opposite to the proximal end. When referring to the heating chamber or the inductor coil, the term ‘proximal’ refers to the region closest to the open end of the heating chamber and the term ‘distal’ refers to the region closest to the closed end. The ends of the aerosol-generating device or the heating chamber may also be referred to in relation to the direction in which air flows through the aerosol-generating device. The proximal end may be referred to as the ‘downstream’ end and the distal end referred to as the ‘upstream’ end.

As used herein, the term ‘length’ refers to the major dimension in a longitudinal direction of the heating chamber, of the aerosol-generating device, of the aerosol-generating article, or of a component of the aerosol-generating device, or of the aerosol-generating article.

As used herein, the term ‘width’ refers to the major dimension in a transverse direction of the heating chamber, of the aerosol-generating device, of the aerosol-generating article, or of a component of the aerosol-generating device, or of the aerosol-generating article, at a particular location along its length. The term ‘thickness’ refers to the dimension in a transverse direction perpendicular to the width.

Below, there is provided a non-exhaustive list of non-limiting examples. Any one or more of the features of these examples may be combined with any one or more features of another example, embodiment, or aspect described herein.

Example A: An aerosol-generating device comprising,
a heating chamber for receiving an aerosol-forming substrate, and
a heater assembly for heating the aerosol-forming substrate,
   wherein the heater assembly comprises a photonic device configured for generating a beam of electromagnetic radiation, and
wherein the aerosol-generating device is configured for heating the aerosol-forming substrate by directing the beam of electromagnetic radiation towards the aerosol-forming substrate.

Example B: The aerosol-generating device according to Example A,
wherein the heating chamber comprises a first side wall parallel to a longitudinal axis of the heating chamber, and a second side wall arranged in perpendicular to the first side wall,
wherein the surface of the first side wall is larger than the surface of the second side wall, and
wherein the aerosol-generating device is configured for heating the aerosol-forming substrate by directing the beam of electromagnetic radiation through at least a portion of the first side wall of the heating chamber and towards the aerosol-forming substrate.

Example C: The aerosol-generating device according to Example B, comprising a beam guiding means for directing the beam of electromagnetic radiation towards the first side wall of the heating chamber.

Example D: The aerosol-generating device according to Example C, wherein the beam guiding means comprises a reflective surface arranged to deflect an incident beam of electromagnetic radiation towards the heating chamber.

Example E: The aerosol-generating device according to Example D, wherein the reflective surface is arranged on an inclined wall of the aerosol-generating device, wherein the inclined wall is inclined at an angle smaller than 90 degrees with respect to a longitudinal axis of the aerosol-generating device, and wherein the inclined wall is arranged coaxially around the first side wall of the heating chamber, preferably, wherein the first side wall of the heating chamber comprises an IR transparent material.

Example F: The aerosol-generating device according to any of Example C to E, wherein the beam guiding means comprises an IR reflecting material.

Example G: The aerosol-generating device according to according to any of Examples B to F, comprising an airflow path extending through the heating chamber in a direction parallel to the first side wall of the heating chamber.

Example H: The aerosol-generating device according to any of the preceding examples, wherein the photonic device comprises a light source.

Example I: The aerosol-generating device according to any of the preceding examples, wherein the photonic device comprises one or more of semiconductor-based electronics, a light-emitting diode, a laser diode, and an IR emitter.

Example J: The aerosol-generating device according to any of the preceding examples, wherein the photonic device comprises an IR laser diode.

Example K: The aerosol-generating device according to any of the preceding examples, wherein the photonic device is configured for emitting electromagnetic radiation in a range of wavelengths of between 800 nanometers and 2500 nanometers, preferably between 1100 nanometers and 2000 nanometers, more preferably between 1400 nanometers and 1700 nanometers, and most preferably about 1550 nanometers.

Example L: The aerosol-generating device according to any of the preceding examples, wherein the photonic device is configured for irradiating a surface area of the aerosol-forming substrate of between 0.1 square centimeter and 10 square centimeters, preferably between 0.2 square centimeter and 4.1 square centimeters, and more preferably about 2 square centimeters.

Example M: The aerosol-generating device according to any of the preceding examples, wherein the power of the beam of electromagnetic radiation is in the range of between 0.1 Watt and 30 Watts, preferably between 0.5 Watt and 25 Watts, more preferably between 2 Watts and 6 Watts, and most preferably about 4 Watts.

Example N: The aerosol-generating device according to any of the preceding examples, wherein the energy density of the beam of electromagnetic radiation is in a range of from 0.5 Watt per square centimeter to 100 Watts per square centimeter, preferably from 1 Watt per square centimeter to 20 Watts per square centimeter, and more preferably from 2 Watts per square centimeter to 6 Watts per square centimeter.

Example O: The aerosol-generating device according to any of the preceding examples, wherein the aerosol-generating device is configured such that a distance along an optical path between the photonic device and a surface of the aerosol-forming substrate is between 0.1 centimeter and 50 centimeters, preferably between 2 centimeters and 30 centimeters.

Example P: The aerosol-generating device according to any of the preceding examples, comprising a cooling system for cooling the photonic device, wherein the cooling system comprises an airflow path extending from an air inlet to the heating chamber past the photonic device.

Example Q: The aerosol-generating device according to any of the preceding examples, comprising a safety interlock switch.

Example R: The aerosol-generating device according to any of the preceding examples, wherein the heating chamber is arranged between the photonic device and a mouth-end of the aerosol-generating device with respect to a longitudinal axis of the aerosol-generating device.

Example S: The aerosol-generating device according to any of the preceding examples, comprising a re-closable lid for insertion of the aerosol-forming substrate into the heating chamber.

Example T: The aerosol-generating device according to Example S, wherein the re-closable lid is located at a side wall of the aerosol-generating device between a proximal end of the heating chamber and a distal end of the heating chamber with respect to a longitudinal axis of the aerosol-generating device.

Example U: The aerosol-generating device according to Example S or Example T, wherein the re-closable lid comprises a hinged door or a sliding door.

Example V: The aerosol-generating device according to any of Examples B to U, wherein at least a portion of the first side wall of the heating chamber comprises a window being substantially transparent for the beam of electromagnetic radiation emitted by the photonic device, preferably, wherein the window is located at a distal end of the heating chamber.

Example W: The aerosol-generating device according to Example V, wherein the window comprises one or more of fused silica, lithium fluoride, magnesium fluoride, calcium fluoride, barium fluoride, silicon, germanium, copper, zinc selenide, and sapphire.

Example X: The aerosol-generating device according to any of the preceding examples, wherein at least a portion of a wall of the heating chamber comprises an IR blocking material, preferably, wherein the IR blocking material is located at a proximal end of the heating chamber with respect to a longitudinal axis of the aerosol-generating device.

Example Y: The aerosol-generating device according to any of the preceding examples, wherein one or both of an inner side of a wall of the heating chamber and an inner side of a wall of the aerosol-generating device comprises or is coated with an IR reflecting material.

Example Z: The aerosol-generating device according to Example Y, wherein the IR reflecting material comprises a metal, preferably, aluminium, gold, silver, or any combination or alloy thereof.

Example ZA: The aerosol-generating device according to Example Y or Example Z, comprising a protective coating on the IR reflecting material, preferably, wherein the protective coating comprises SiO2 or SiO.

Example ZB: The aerosol-generating device according to any of Examples Y to ZA, wherein a wall of the aerosol-generating device comprising the IR reflecting material is inclined at an angle smaller than 90 degrees with respect to a longitudinal axis of the aerosol-generating device.

Example ZC: The aerosol-generating device according to Example ZB, wherein the inclined wall of the aerosol-generating device is arranged coaxially around a side wall of the heating chamber, preferably, wherein the side wall of the heating chamber comprises an IR transparent material.

Example ZD: The aerosol-generating device according to any of the preceding examples, wherein the aerosol-generating device is a hand-held device.

Example ZE: The aerosol-generating device according to any of the preceding examples, wherein the aerosol-generating device is a heat-not-burn device.

Example ZF: An aerosol-generating system, comprising the aerosol-generating device according to any of the preceding examples and an aerosol-generating article comprising the aerosol-forming substrate, wherein the aerosol-generating article is configured to be at least partly inserted into the heating chamber.

Example ZG: The aerosol-generating system according to Example ZF, wherein the aerosol-forming substrate comprises cast leaf.

Example ZH: The aerosol-generating system according to Example ZF or Example ZG, wherein the aerosol-forming substrate has the shape of a disc or a sheet.

Example ZI: The aerosol-generating system according to Example ZH, wherein the aerosol-forming substrate has a diameter of between 5 millimeters and 15 millimeters, preferably about 15 millimeters, and wherein the aerosol-forming substrate has a thickness of between 1 millimeter and 10 millimeters, preferably about 5 millimeters.

Example ZJ: The aerosol-generating system according to any of Examples ZF to ZI, wherein the aerosol-forming substrate has a mass of between 100 milligrams and 1 gram, preferably about 400 milligrams.

Example ZK: A method for forming an aerosol in an aerosol-generating device, comprising steps of
generating a beam of electromagnetic radiation by means of a photonic device;
directing the beam of electromagnetic radiation from the photonic device towards an aerosol-forming substrate;
heating the aerosol-forming substrate by means of the beam of electromagnetic radiation to generate an aerosol.

Features described in relation to one embodiment may equally be applied to other embodiments of the invention.

The invention will be further described, by way of example only, with reference to the accompanying drawings in which:

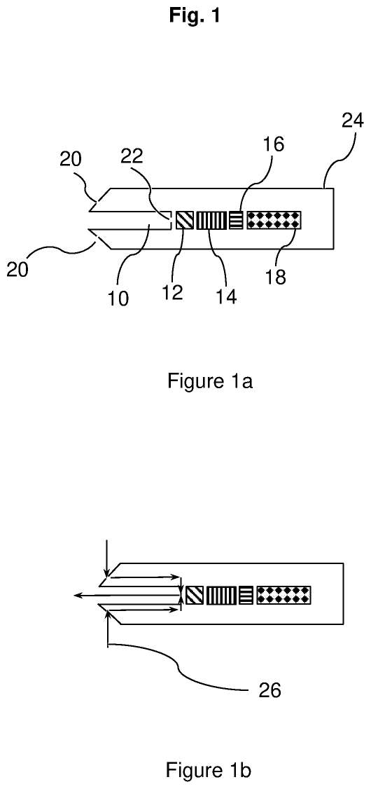

FIGS. 1a and 1b show an aerosol-generating device;

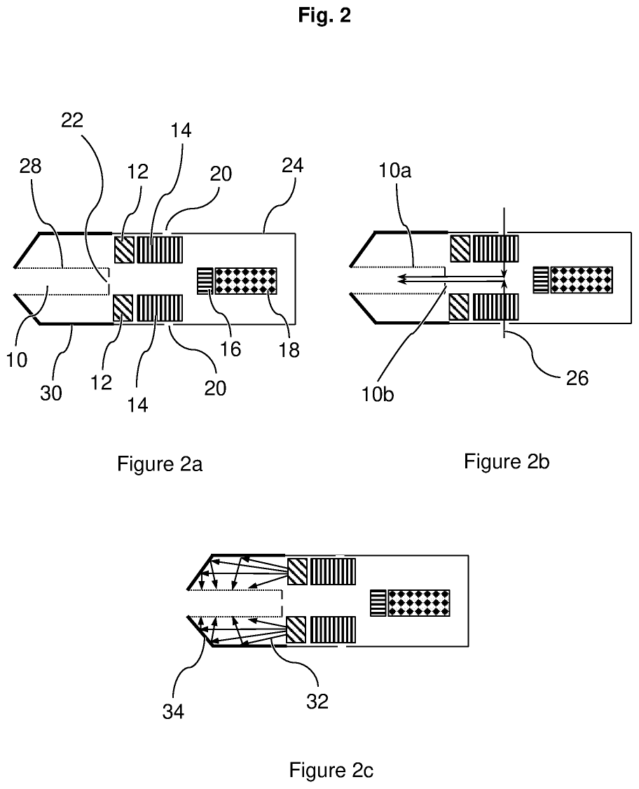

FIGS. 2a to 2c show an aerosol-generating device;

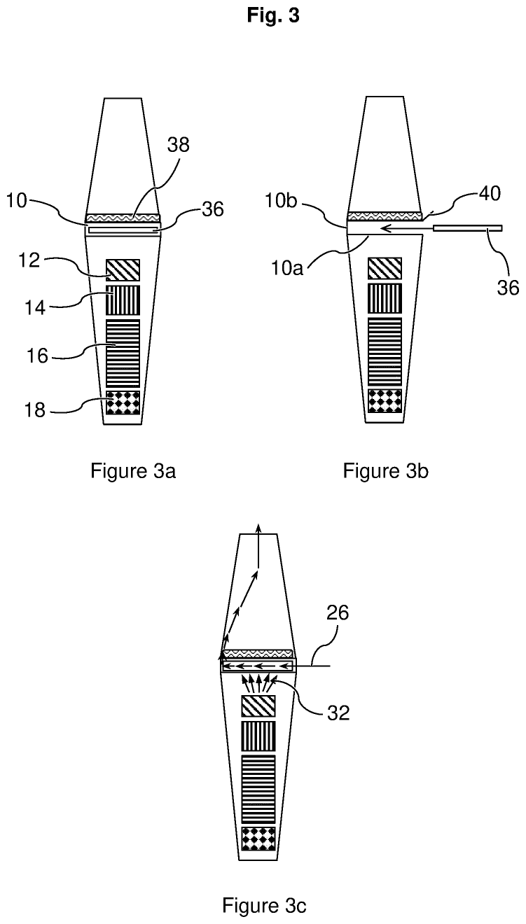

FIGS. 3a to 3c show an aerosol-generating device; and

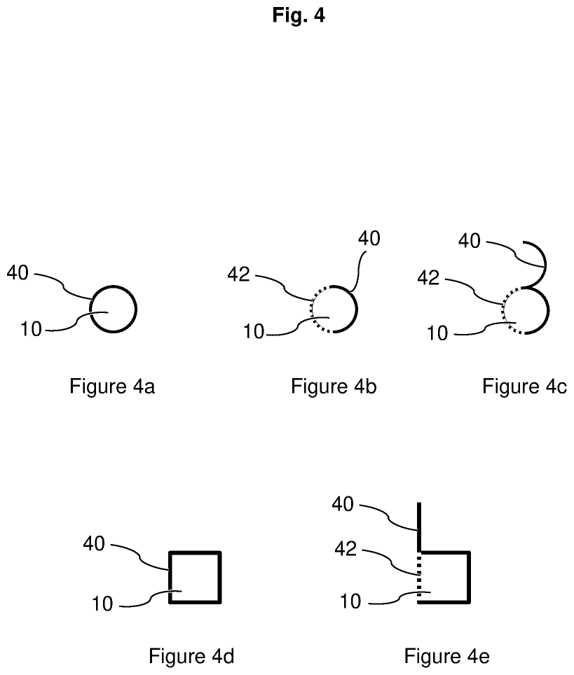

FIGS. 4a to 4e show heating chambers of an aerosol-generating device.

FIGS. 1a and 1b show cross-sections of an aerosol-generating device in side view. aerosol-generating device of FIGS. 1a and 1b is oriented such that the mouth-end side of the device is at the left-hand side of the figure.

As indicated in FIG. 1a, the aerosol-generating device of FIGS. 1a and 1b comprises a heating chamber 10 for receiving an aerosol-forming substrate. The aerosol-generating device comprises a heater assembly for heating the aerosol-forming substrate. The heater assembly comprises a photonic device 12 configured for generating a beam of electromagnetic radiation. The aerosol-generating device is configured for heating the aerosol-forming substrate by directing the beam of electromagnetic radiation towards the aerosol-forming substrate when being inserted into the heating chamber 10.

The aerosol-generating device further comprises a cooling system 14 for cooling the photonic device 12. The aerosol-generating device comprises a control unit 16 for controlling operation of the device. The aerosol-generating device comprises a power supply 18 for supplying electrical power to the device.

The aerosol-generating device further comprises air inlets 20, 22. The air inlets 20, 22 are formed as apertures in a housing 24 of the aerosol-generating device.

Arrows 26 in FIG. 1b illustrate the airflow path in the aerosol-generating device of FIGS. 1a and 1b. Ambient air enters the aerosol-generating device via air inlets 20 and then enters the heating chamber 10 via air inlet 22. In use, an aerosol-forming substrate is inserted into the heating chamber and the air may flow through or past the aerosol-forming substrate. Finally, the air comprising an aerosol generated by the aerosol-forming substrate exists the heating chamber 10 at the mouth-end side of the aerosol-generating device, i.e. the left-hand side of FIGS. 1a and 1b. The aerosol-forming substrate may be part of an aerosol-generating article. The aerosol-forming-substrate may be part of a distal portion of the aerosol-generating article. The distal portion of the article may be inserted into the heating chamber 10. The aerosol-generating article may comprise a mouthpiece such as a mouthpiece filter element at its proximal end thereof. In use, a user may draw directly on the mouthpiece of the aerosol-generating article.

FIGS. 2a to 2c show cross-sections of an aerosol-generating device in side view. The aerosol-generating device of FIGS. 2a to 2c is oriented such that the mouth-end side of the device is oriented towards the left-hand side of the figure.

As indicated in FIG. 2a, the aerosol-generating device of FIGS. 2a to 2c comprises a heating chamber 10 for receiving an aerosol-forming substrate and a heater assembly for heating the aerosol-forming substrate. As indicated in FIG. 2b, the heating chamber 10 comprises a first side wall 10a parallel to a longitudinal axis of the heating chamber 10. The heating chamber 10 comprises a second side wall 10b arranged in perpendicular to the first side wall 10a. The surface of the first side wall 10a is larger than the surface of the second side wall 10b.

As indicated in FIG. 2a, the heater assembly comprises a photonic device 12. The photonic device 12 is arranged between the heating chamber 10 and an outer side wall of the housing 24 with respect to a transversal direction. The photonic device 12 may comprise a ring-shaped light source with the ring circumscribing a longitudinal center axis of the aerosol-generating device. Alternatively, the photonic device 12 may comprise one or more light sources arranged circumferentially around the heating chamber in a transversal plane of the aerosol-generating device.

The photonic device 12 comprises an IR emitter, for example an IR laser diode. The IR emitter is configured for generating an IR beam. The aerosol-generating device is configured for heating the aerosol-forming substrate by directing the IR beam through the first side wall 12a of the heating chamber 10 and towards the aerosol-forming substrate when being inserted into the heating chamber 10.

The aerosol-generating device comprises a cooling system 14, a control unit 16, a power supply 18, and a device housing 24. The aerosol-generating device further comprises air inlets 20, 22. Arrows 26 in FIG. 2b illustrate the airflow path in the aerosol-generating device of FIGS. 2a to 2c. Air inlets 20 are positioned near the cooling system 14. This may further enhance the cooling capabilities through air convection.

As indicated in FIG. 2a, the first side wall 10a of the heating chamber comprises an IR transparent material 28, for example fused silica. An inner side of a wall of the housing 24 coaxially surrounding the heating chamber 10 comprises an IR reflective material 30, for example aluminum.

Arrows 32 in FIG. 2c illustrate IR beam propagation when the photonic device 12 is activated. Beams 32 of IR light exit the photonic device 12. Depending on the beam direction, beams 32 may directly enter the heating chamber 10 through the IR transparent material 28, or they may be first reflected at the IR reflective material 30 before entering the heating chamber 10 through the IR transparent material 28. The IR reflective material 30 thus functions as a beam guiding means. An aerosol-forming substrate located within the heating chamber 10 may be heated to generate an aerosol by means of the IR beams 32 entering the heating chamber 10 through the first side wall 12a via the IR transparent material 28.

The possibility to reflect and scatter light is exploited to irradiate a large portion of the aerosol-forming substrate through the transmissive first side wall 10a of the heating chamber 10. Thereby a flat thermal gradient may be achieved.

Reflectance of the IR beams 32 into the heating chamber 10 is advantageously promoted by a wall 34 of the aerosol-generating device comprising the IR reflecting material 30 and being inclined at an angle smaller than 90 degrees with respect to a longitudinal axis of the aerosol-generating device. Wall 34 thus functions as a beam guiding means. The angle may be optimized with respect to light direction and substrate position.

FIGS. 3a to 3c show cross-sections of an aerosol-generating device in side view. The aerosol-generating device of FIGS. 3a to 3c is oriented such that the mouth-end side of the device is oriented towards the top of the figure.

As indicated in FIG. 3a, the aerosol-generating device of FIGS. 3a to 3c comprises a heating chamber 10 for receiving an aerosol-forming substrate 36 and a heater assembly for heating the aerosol-forming substrate 36. The heater assembly comprises a photonic device 12. The heating chamber 10 is arranged between the photonic device 12 and a mouth-end of the aerosol-generating device with respect to a longitudinal axis of the aerosol-generating device. The bottom wall of the heating chamber facing the photonic device 12 is made of a material transparent for electromagnetic radiation, for example IR light.

The aerosol-generating device further comprises a cooling system 14, a control unit 16, a power supply 18, and a device housing 24. Air inlets are present but are not shown in FIG. 3.

The aerosol-forming substrate 36 may be inserted into the heating chamber 10 via a re-closable lid 40 comprising a hinged door as illustrated in FIG. 3b. The re-closable lid 40 is located at a side wall of the aerosol-generating device between a proximal end of the heating chamber 10 and a distal end of the heating chamber 10 with respect to a longitudinal axis of the aerosol-generating device. FIG. 3b also indicates that the heating chamber 10 comprises a first side wall 10a parallel to a longitudinal axis of the heating chamber 10 and perpendicular to a longitudinal axis of the aerosol-generating device. The heating chamber 10 comprises a second side wall 10b arranged in perpendicular to the first side wall 10a. The surface of the first side wall 10a is larger than the surface of the second side wall 10b.

The aerosol-generating device of FIGS. 3a to 3c further comprises a safety window 38. The safety window 38 is impermeable for the electromagnetic radiation, for example IR radiation, emitted by photonic device 12. The safety window 38 may comprise an IR blocking material. Therefore, the safety window 38 may prevent potentially harmful IR radiation 32 shown in FIG. 3c to propagate towards the mouth end of the aerosol-generating device and irradiate a user.

The safety window 38 may comprise a reflective material. For example, an IR reflective coating may be present towards the interior of the heating chamber such that the incident IR beam may be reflected back towards the heating chamber 12. The IR reflective coating may thus function as a beam guiding means.

FIGS. 4a to 4e show cross-sections of heating chambers 10 of an aerosol-generating device in top view.

FIG. 4a shows a heating chamber 10 with a circular cross-section with its lid 40 in the closed configuration. FIG. 4b shows a heating chamber 10 with a circular cross-section with its lid 40 in the opened configuration, the lid 40 comprising a sliding door. An aerosol-forming substrate may be inserted via an aperture 42. FIG. 4c shows a heating chamber 10 with a circular cross-section with its lid 40 in the opened configuration, the lid 40 comprising a hinged door. FIG. 4d shows a heating chamber 10 with a rectangular cross-section with its lid 40 in the closed configuration. FIG. 4e shows a heating chamber 10 with a rectangular cross-section with its lid 40 in the opened configuration. The lid 40 of FIGS. 4a to 4e may comprise a safety interlock switch such that the photonic device 12 can only be operated when the aperture 42 is closed.

1.-14. (canceled)

15. An aerosol-generating device, comprising:
a heating chamber configured to receive an aerosol-forming substrate; and
a heater assembly configured to heat the aerosol-forming substrate,
wherein the heater assembly comprises a photonic device configured to generate a beam of electromagnetic radiation,
wherein the aerosol-generating device is configured to heat the aerosol-forming substrate by directing the beam of electromagnetic radiation onto the aerosol-forming substrate, and
wherein the heating chamber is arranged between the photonic device and a mouth-end of the aerosol-generating device with respect to a longitudinal axis of the aerosol-generating device.

16. The aerosol-generating device according to claim 15,
wherein the heating chamber comprises a first side wall parallel to a longitudinal axis of the heating chamber, and a second side wall arranged perpendicular to the first side wall,
wherein a surface of the first side wall is larger than a surface of the second side wall, and
wherein the aerosol-generating device is further configured to heat the aerosol-forming substrate by directing the beam of electromagnetic radiation through at least a portion of the first side wall of the heating chamber and towards the aerosol-forming substrate.

17. The aerosol-generating device according to claim 16, further comprising a beam guiding means for directing the beam of electromagnetic radiation towards the first side wall of the heating chamber.

18. The aerosol-generating device according to claim 17, wherein the beam guiding means comprises a reflective surface arranged to deflect an incident beam of electromagnetic radiation towards the heating chamber.

19. The aerosol-generating device according to claim 18,
wherein the reflective surface is arranged on an inclined wall of the aerosol-generating device,
wherein the inclined wall is inclined at an angle smaller than 90 degrees with respect to the longitudinal axis of the aerosol-generating device, and
wherein the inclined wall is arranged coaxially around the first side wall of the heating chamber.

20. The aerosol-generating device according to claim 19, wherein the first side wall of the heating chamber comprises an IR-transparent material.

21. The aerosol-generating device according to claim 17, wherein the beam guiding means comprises an IR-reflecting material.

22. The aerosol-generating device according to claim 16, further comprising an airflow path extending through the heating chamber in a direction parallel to the first side wall of the heating chamber.

23. The aerosol-generating device according to claim 16, wherein at least a portion of the first side wall of the heating chamber comprises a window being substantially transparent for the beam of electromagnetic radiation emitted by the photonic device.

24. The aerosol-generating device according to claim 23, wherein the window is located at a distal end of the heating chamber.

25. The aerosol-generating device according to claim 23, wherein the window comprises one or more of fused silica, lithium fluoride, magnesium fluoride, calcium fluoride, barium fluoride, silicon, germanium, copper, zinc selenide, and sapphire.

26. The aerosol-generating device according to claim 15, wherein the photonic device comprises an IR laser diode.

27. The aerosol-generating device according to claim 15,
further comprising a cooling system configured to cool the photonic device,
wherein the cooling system comprises an airflow path extending from an air inlet to the heating chamber past the photonic device.

28. The aerosol-generating device according to claim 15, wherein at least a portion of a wall of the heating chamber comprises an IR-blocking material.

29. The aerosol-generating device according to claim 28, wherein the IR-blocking material is located at a proximal end of the heating chamber with respect to the longitudinal axis of the aerosol-generating device.

30. The aerosol-generating device according to claim 15, wherein one or both of an inner side of a wall of the heating chamber and an inner side of a wall of the aerosol-generating device comprises or is coated with an IR-reflecting material.

31. An aerosol-generating system, comprising the aerosol-generating device according to claim 15, and an aerosol-generating article comprising the aerosol-forming substrate, wherein the aerosol-generating article is configured to be at least partly inserted into the heating chamber.
